(19) United States
(12) Patent Application Publication
(10) Pub. No.: US 2001/0011602 A1
(43) Pub. Date: Aug. 9, 2001

(54) Electrical cable

(76) Inventor: Bruno Vitolo, Agropoli (IT)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/739,651

(22) Filed: Dec. 20, 2000

(30) Foreign Application Priority Data
Dec. 21, 1999 (IT) MI99A002652

(51) Int. Cl. H01B 11/02

(52) U.S. Cl. 174/117 R

(57) ABSTRACT

An electrical cable is described comprising a threadlike conductor, an insulator and a sheat. The cable according to the invention is characterized in that the outer surface of said sheat has some portions standing out with respect to an average line and portions which are below it. In particular, the portions standing out with respect to an average line and the portions which are below it define a plurality of longitudinal grooves. the cable according to the invention has many advantages over conventional cables such as a greater heat-loss capability, a greater flexibility, smaller overall dimensions and lower laying friction of the cable itself.

### BACKGROUND OF THE INVENTION

1. Field of the Invention

The present invention relates to the field of cables and in particular to electrical cables. Still more in particular it concerns an improved electrical cable with grooved outer surface.

2. Description of the Prior Art

As it is known, a conventional electrical cable comprises one or more threadlike conductors surrounded by an insulating material; the conductor/s is/are contained in a sheath, still of insulating material; generally, especially in the case of multiconductor cables, a filler is interposed between insulator and sheath.

As it is also known, once the maximum operating temperature has been set, the types of materials to be used and the thickness of the sheath and of the insulation, other parameters such as the current which can flow, the temperatures reaceable by the insulator and the sheath, the cable voltage drop and the various manufacturing costs (depending on the amount of material utilized) can be calculated.

The conductor temperature being equal, the insulation and sheath thickness reduction results in a current reduction, an increase in the temperature on the insulator and on the outer sheath and a reduction of the voltage drop; on the contrary, the sheath and insulation thickness being equal, should the external temperature rise (for instance from 90° C. to 100° C.), the current increases slightly, the temperature on the insulator and the sheath as well as the voltage drop will rise. In both cases the external temperature of the cable is too high to satisfy the safety requirements.

In practice, for a given section of an electrical cable, if the conductor and ambient temperature is fixed, the current depends on the capability of the cable to transfer heat to the outside.

### SUMMARY OF THE INVENTION

Therefore, from the above considerations, one understands how there is a need for the provision of electrical cables which, at a pre-established current level, exhibit temperatures lower than those of the conventional cables, naturally without increasing too much the thickness of the insulating material (and/or of the sheath) and hence the overall dimensions of the cable.

Another object is to provide an electrical cable with lower electrical losses.

A further object is to provide a cable with increased strength as compared with conventional cables.

Still another object is to provide an electrical cable with an improved behaviour against both flame and fire.

Another object is to provide an electrical cable featuring good flexibility and low friction, properties which are particularly appreciated during the operations of laying the cables or of installing equipment connected thereto.

The above and further objects are achieved by the cable according to the present invention having the features set forth in the independent claim 1. Further advantageous characteristics of the cable according to the present invention are set forth in the dependent claims. All the claims are however considered an integral part of the present description.

The characteristic feature of the present invention consists in the structure of the sheath surface that exhibits a plurality of grooves which, at parity of external diameter of the cable, considerably increase the surface and facilitate the heat exchange with the outside. The presence of grooves results in a reduction of the overall weight of the cable and in an improved handiness thereof. Moreover, the grooved cable is definitely more flexible and more sliding. The reduction in the material used for manufacturing the sheath leads intrinsically to an economic saving and to beneficial environmental effects.

The invention will certainly result in being clear having read the following detailed description, to be read with reference to the attached drawing sheets.

### BRIEF DESCRIPTION OF THE DRAWINGS

In the drawings:

FIG. 1 shows, in cross section, a conventional single-conductor electrical cable;

FIG. 2 shows, in cross-section, a conventional multiconductor electrical cable;

FIG. 3 shows, in cross-section, an electrical cable according to the present invention having a sole conductor; and

FIG. 4 shows, in cross-section, an electrical cable according to the present invention having three conductors.

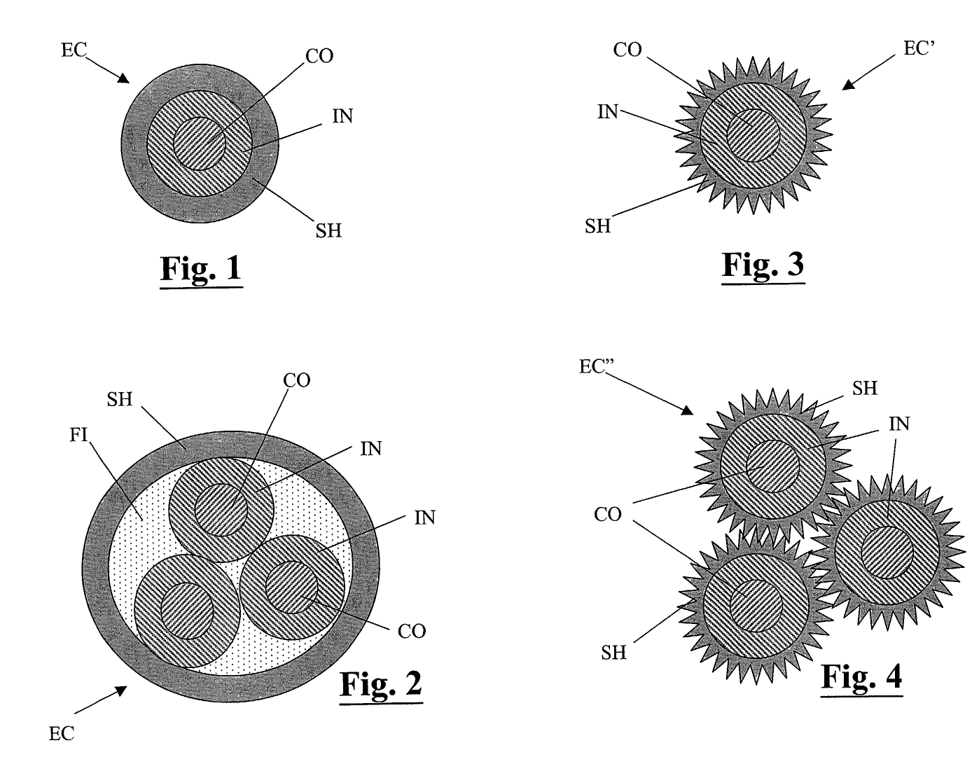

The same reference characters will be used throughout various figures to indicate the same parts or functionally equivalent parts.

### BEST MODE FOR CARRYING OUT THE INVENTION

As said beforehand above, a conventional single-conductor electrical cable EC comprises: a threadlike conductor CO applied around which is an insulation layer IN which in turn is surrounded by a sheath SH.

A conventional multiconductor electrical cable EC, for instance the three-conductor cable of FIG. 2, comprises three threadlike conductors CO applied around which is a respective insulation layer IN. The electrical cable of FIG. 2 further comprises a sheath SH enclosing the three conductors CO. The difference from the single-conductor cable consists in the presence of a filter FI that fills-in the empty spaces between sheath and insulation.

With reference to FIG. 3, the single-conductor electrical cable EC according to the present invention comprises the same parts as the known single-conductor cable (a threadlike conductor CO, an insulator IN and a sheath SH) but the difference lies in that the sheath exhibits a plurality of longitudinal grooves resulting in a toothed or notched section when the cable is seen in a cross-sectional view. It will be understood that a section of this type considerably increases the outer surface at the sheath, the external diameter of the sheath itself being equal. The increase in the surface, in turn, results in an improvement in thermal exchange and therefore in a drop in the temperature on the insulation and on the sheath.

Among the further advantages achieved with a configuration like that illustrated in FIG. 3 is a significant material saving, to the advantage of the environmental pollution and of the economic saving. The cable according to the present invention further results in being much more flexible, handly and sliding than a conventional cable having similar characteristics.

FIG. 4 illustrates an electrical cable EC′ according to the present invention and comprising three insulated conductors CO. Each of the insulated conductors is surrounded by insulation IN and by a respective sheath SH with grooves similar to those of FIG. 3. The person skilled in the art will appreciate that with the multiconductor cable according to the present invention it is not necessary to use any filler in contrast with the known cables. The consequent advantage is economic and environmental nature, and in terms of lightness, handiness and smoothness of the cable. The cable according to the present invention further has a smaller section than a conventional cable.

Hence in practice, the three-conductor cables of FIG. 4 comprises three single conductor cables of FIG. 3 that can be assembled in various ways. The simplest, most practical and economic way is that in which the three conductors are twisted/thrown together. In this way the crests of the grooves of a cable advantageously fit in the recesses of the other cables. An alternative to the solution of twisting the single-conductor is the possibility of gluing them each other (also in this case the possibility of fitting crests and recesses of a cable with the corresponding recesses and crests of the other cables is particularly advantageous).

A further possibility, being less preferable then the previous ones, is to provide that the portion between the contact areas of the sheaths is full, i.e. of the same material as the sheath itself. This solution is less preferred because all the advantages mentioned above could not be achieved.

In view of the improved heat loss capability provided by the grooves in the sheath, it is also possible to reduce the thickness of insulation and/or sheath insulation and/or sheath by about 10 to 40% with respect to the thickness of conventional cables, up to 50% of such values. The cable is thus smaller and lighter, more flexible, easier to manufacture, to stock, to transport and to install. In addition, the energy used for the production thereof is less than the energy necessary to produce conventional cables, increasing the beneficial effect on the environment.

Although the solution which is subject-matter of the present invention in principle can be used at low, medium and high voltage it is deemed that the most appropriate field of use is the low voltage one (from 0.6 to 1.2 kV) since for medium high voltage, the insulation thickness becomes of proportionally higher importance.

Another advantage of the cable according to the invention achieved through the presence of the grooves, is the increased flameproof capability.

Lastly, notwithstanding the preferred solution for increasing the outer surface at the sheath is embodied through the construction of a plurality of longitudinal grooves, preferably of substantially equal sizes, a similar effect could be achieved through the realization of discontinuous projections in the longitudinal direction but this would result in manufacture complication. A possible solution could be to realize longitudinal grooves (for instance by extrusion) and subsequently pass the grooved cable through a sort of threading die like those used to thread; the order of the two working steps could naturally be invented (first the passage through the threading die and then the realization of the grooves). This solution is not illustrated but it is considered apparent to a person skilled in the art in view of the description thereof.

Naturally, although in the present description and in the appended claims reference is only made to (longitudinal) “grooves” for the purposes of clarity in this patent application, the term “groove” must be intended in a broader sense so as to include every possible configuration wherein some portions of the sheath surface project above an average line and other portions of the sheath surface are below such a line. In other words, if one considers a looped line circling the insulating material IN, the crests of grooved sheath SH will be projecting above such an average line while the valleys of sheath SH will be below such a line.

It is therefore apparent that the concepts set forth above lend themselves to small variations and changes which are deemed as falling within the scope defined by the following claims.

What is claimed is:

1. An electrical cable comprising a threadlike conductor, an insulator and a sheath with an outer surface, wherein the outer surface of said sheath comprises some portions projecting above an average line circling the insulator and portions which are below such an average line.

2. An electrical cable according to claim 1, wherein said portions of sheath projecting above the average line and said portions of sheath which are below it define a plurality of longitudinal grooves.

3. An electrical cable according to claim 1 or 2, wherein it is associated with one or more similar cables for the construction of a multiconductor cable, said cables being associated with each other by twisting them together.

4. An electrical cable according to claim 2, wherein it is associated with one or more similar cables for the construction of a multiconductor cable, said cables being associated with each other by twisting them together.

5. An electrical cable according to claim 1, wherein it is associated with one or more similar cables for the construction of a multiconductor cable (EC″), said cables being associated with each other by gluing.

6. An electrical cable according to claim 2, wherein it is associated with one or more similar cables for the construction of a multiconductor cable (EC″), said cables being associated with each other by gluing.

7. An electrical cable according to claim 2, wherein it is associated with one or more similar cables for the construction of a multiconductor cable , said cables being associated with each other in such a way that the area comprised between the contact points of one cable with the others is occupied by the same material as the sheath.

8. An electrical cable according to claim 1, wherein the thickness of said sheath and/or of said insulator is reduced as compared with an electrical cable with a smooth outer surface of the sheath, having the same characteristics and operating under the same environmental conditions.
